(19) United States
(12) Patent Application Publication
(10) Pub. No.: US 2007/0014225 A1
(43) Pub. Date: Jan. 18, 2007

(54) Optical recording medium

(75) Inventors: Koji Mishima, Tokyo (JP); Daisuke Yoshitoku, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/486,052

(22) Filed: Jul. 14, 2006

(30) Foreign Application Priority Data
Jul. 15, 2005 (JP) 2005-207239
Apr. 21, 2006 (JP) 2006-118517

(51) Int. Cl. G11B 7/24

(52) U.S. Cl. 369/275.1

(57) ABSTRACT

An optical recording medium is provided which has a plurality of recording layers, in which a favorable recording mark can be formed and desired reproduction accuracy can be obtained in any of the recording layers. The optical recording medium has a first recording layer and a second recording layer. In the first and second layers, a recording mark, having an increased thickness larger than that of a neighboring space portion, is formed by an irradiation with a laser beam. The refractive index of the second recording layer placed relatively closer to an incident surface of a laser beam is lower than that of the first recording layer placed farther away from the incident surface of the laser beam than the second recording layer.

### BACKGROUND OF THE INVENTION

1. Field of the Invention

The present invention relates to an optical recording medium having a plurality of recording layers.

2. Description of the Related Art

Optical recording media such as CDs (Compact Discs) and DVDs (Digital Versatile Discs) have been used extensively as information recording media. Moreover, in recent years, attention is being paid to an optical recording medium which utilizes a blue or blue-violet laser beam as an irradiation beam and thus capable of recording a larger amount of information than conventional media.

Optical recording media are broadly categorized into a ROM (Read Only Memory) type in which data cannot be added or rewritten, an RW (Rewritable Memory) type in which data can be rewritten, and an R (Recordable) type in which data can be written only once.

In the R type optical recording medium, data is recorded by an irradiation with a laser beam onto a recording layer to form a recording mark which has a reflectivity lower than that of a neighboring space portion. Here, although the recording laser beam is also projected onto the space portion around the recording mark, the amount of the recording laser beam projected onto the space portion is small. Therefore, the reflectivity of the space portion is the same as the reflectivity of the recording layer prior to the laser beam projection. On the other hand, in an R type optical recording medium, data is reproduced by projecting a laser beam onto the recording layer to detect the difference in reflectivity between the recording mark and the space portion with a photodetector.

In such optical recording media, if a plurality of recording layers are provided, the recording capacity can be correspondingly increased. When data is recorded in an R type optical recording medium which has a plurality of recording layers, the data can be selectively recorded in a target recording layer by adjusting the focus of a recording laser beam on the target recording layer. Furthermore, data stored in a target recording layer can be selectively reproduced by adjusting the focus of a reproducing laser beam onto the target recording layer.

Preferably, in such an R type optical recording medium which has a plurality of recording layers, when each of the recording layers is irradiated with a reproducing laser beam of the same power, the reflected light from each of the recording layers is detected by a photodetector such that the intensity values of all the reflected lights are close. Specifically, it is preferable that the reflected lights from two adjacent recording layers be detected by the photodetector such that the detected reflectivity values thereof are close, i.e., the higher reflectivity value is less than twice the lower reflectivity value.

However, a lower recording layer placed relatively far from an incident surface of a laser beam is irradiated with the laser beam through upper recording layer. Part of this laser beam is absorbed by the upper recording layer, and thus the amount of the laser beam reaching the lower recording layer is correspondingly decreased.

Therefore, when the power of the reproducing laser beam projected onto the lower recording layer is the same as that of the reproducing laser beam projected onto the upper recording layer, the amount of the laser beam reaching the lower recording layer is less than that of the laser beam reaching the upper recording layer. Furthermore, since the reflected light of the laser beam projected onto the lower recording layer reaches the photodetector through the upper recording layer, part of the reflected light is also absorbed by the upper recording layer. Therefore, when the power of the reproducing laser beam projected onto the lower recording layer is the same as that of the reproducing laser beam projected onto the upper recording layer, and when the reflectivity of the lower recording layer is the same as that of the upper recording layer, the reflected lights are detected by the photodetector such that the detected reflectivity value of the lower recording layer is less than that of the upper recording layer.

In view of the foregoing, an R type optical recording medium is known in which an upper recording layer is thinner than a lower recording layer (see, for example, Japanese Patent Laid-Open Publication No. 2003-266936). The operation of this medium will be briefly described. FIG. 6 is a graph showing the relationship between the thickness of a single recording layer and the reflectivity thereof. In FIG. 6, a curve designated by the symbol S represents the reflectivity of a space portion of the recording layer, and a curve designated by the symbol M represents the reflectivity of a recording mark.

As shown by the curve S, the reflectivity of the space portion becomes maximum when the recording layer has a certain thickness. Thus, if the recording layer is thicker or thinner than this thickness, the reflectivity decreases. As shown by the curve M, the reflectivity of the recording mark also reaches maximum at approximately the same thickness as in the case of the space portion. Thus, if the recording layer is thicker or thinner than this thickness, the reflectivity decreases. Furthermore, the difference in reflectivity between the recording mark and the space portion reaches maximum at around the thickness at which these reflectivities reach maximum. Thus, if the recording layer is thicker or thinner than this thickness, the difference in reflectivity decreases. Accordingly, when the recording layer is excessively thick or thin, the difference in reflectivity is excessively small, and thus the recording mark cannot be reproduced.

Therefore, for example, when the lower recording layer is formed in a thickness giving a maximum reflectivity, and when the upper recording layer is formed to a thickness smaller than the above thickness, the reflectivity of the lower recording layer can be set higher that that of the upper recording layer. As mentioned above, when the power of the laser beam projected onto the lower recording layer is the same as that of the laser beam projected onto the upper recording layer, the amount of the laser beam reaching the lower recording layer is smaller than the amount of the laser beam reaching the upper recording layer. In addition to this, the reflected light of the laser beam projected onto the lower recording layer reaches a photodetector after a part thereof is absorbed by the upper recording layer. Even in this case, by employing the above configuration, the reflected lights from the lower and upper recording layers can be detected by the photodetector such that the detected reflectivity values of these layers are close.

In a region in which the thickness of the recording layer is larger than the thickness giving the maximum reflectivity, a sufficient difference in reflectivity between the recording mark and the space portion can only be obtained in a narrow range. Moreover, within this range, the reflectivity of the upper recording layer cannot be sufficiently decreased with respect to the reflectivity of the lower recording layer having a reflectivity close to the maximum value. Therefore, also in this respect, the configuration in which the upper recording layer is thinner than the lower recording layer is selected.

Furthermore, by forming the upper recording layer such that the thickness thereof is smaller than that of the lower recording layer, the amount of the laser beam absorbed in the upper recording layer decreases, and the amount of the laser beam reaching the lower recording layer can be effectively increased. Therefore, also in this respect, the configuration in which the upper recording layer is thinner than the lower recording layer is selected.

In addition to the example described above, an R type optical recording medium is known in which the refractive index of an upper recording layer is lower than that of a lower recording layer (see, for example, Japanese Patent Laid-Open Publication No. Hei 9-198709). The operation of this medium will be briefly described. FIG. 7 is a graph showing the relationship between the thickness of a single recording layer and the reflectivity thereof with the refractive index of the recording layer as a parameter. In FIG. 7, a curve designated by the symbol S₁, represents the reflectivity of a space portion of the recording layer having a refractive index of n₁, and a curve designated by the symbol S₂ represents the reflectivity of a space portion of a recording layer having a refractive index of n₂. Here, the condition n₁>n₂ holds. In addition to this, a curve designated by the symbol M₁ represents the reflectivity of a recording mark on the recording layer having a refractive index of n₁, and a curve designated by the symbol M₂ represents the reflectivity of a recording mark on the recording layer having a refractive index of n₂.

As shown in FIG. 7, when the thicknesses of the recording layers are the same, the smaller the refractive index is, the smaller the reflectivity of both the space portion and the recording mark will be. Therefore, by adjusting the refractive index of the lower recording layer to n₁, and by adjusting the refractive index of the upper recording layer to n₂, the reflectivity of the upper recording layer is adjusted lower than that of the- lower recording layer. Hence, the reflected lights from the upper and lower recording layers can be detected by a photodetector such that the detected reflectivity values thereof are close.

However, the thinner the recording layer, the more difficult it is to form the recording mark. Thus, if the thickness of the upper recording layer is smaller than the thickness of the lower recording layer, a favorable recording mark having the desired characteristics would not be formed in the upper recording layer in some cases.

In addition to this, the lower the refractive index of the recording layer, the smaller the difference in reflectivity between the space portion and the recording mark. Thus, if the refractive index of the upper recording layer is lower than that of the lower recording layer, the desired reproduction accuracy would not be obtained in the upper recording layer in some cases.

### SUMMARY OF THE INVENTION

In view of the foregoing problems, various exemplary embodiments of this invention provide an optical recording medium which has a plurality of recording layers, in which a favorable recording mark can be formed and in which desired reproducing accuracy can be obtained in any of the recording layers.

In various exemplary embodiments of the present invention, the above object is achieved by use of an optical recording medium having a plurality of recording layers in which a recording mark, having an increased thickness larger than the thickness of a neighboring space portion, is formed by an irradiation with a laser beam. In this optical recording medium, among the plurality of recording layers, a recording layer placed relatively closer to an incident surface of the laser beam has a refractive index lower than that of a recording layer placed farther away from the incident surface of the laser beam than the abovementioned recording layer placed relatively closer to the incident surface of the laser beam.

Moreover, in various exemplary embodiments of the present invention, the above object is achieved by use of another optical recording medium having a plurality of recording layers in which a recording mark, having an increased thickness larger than the thickness of a neighboring space portion, is formed by an irradiation with a laser beam. In this optical recording medium, among the plurality of recording layers, a recording layer placed relatively closer to an incident surface of a laser beam has an extinction coefficient lower than that of a recording layer placed farther away from the incident surface of the laser beam than the abovementioned recording layer placed relatively closer to the incident surface of the laser beam.

During the course of arriving at the present invention, the present inventors have formed recording layers from various materials. Consequently, the inventors have found that, in a recording layer formed from a certain material, a recording mark, having an increased thickness larger than the thickness of a neighboring space portion, is formed by an irradiation with a laser beam. In addition to this, the inventors have found that this recording layer has an extinction coefficient significantly lower than that of a conventional recording layer.

Since the thickness of the recording mark portion is increased as compared to that of the surrounding portion, the reflectivity of this recording mark is not the same as the reflectivity of a recording mark in the curves designated by the symbols M₁ and M₂ in FIG. 7, but is the same as the reflectivity of a recording mark in a recording layer having a thickness larger by the amount of increase in the thickness. In other words, the relationship between the thickness of the recording layer and the reflectivity of the recording mark is represented by a curve obtained by shifting the curve M₁ or M₂ in FIG. 7 in the direction of lower thicknesses by the amount of increase in the thickness, as shown in FIG. 1. Hence, at around the thickness giving the maximum reflectivity to the space portion and in a region in which the thickness is larger than the above thickness, the difference in reflectivity between the space portion and the recording mark becomes larger. Therefore, for example, in the case in which the thicknesses of lower and upper recording layers are set close to the thickness giving the maximum reflectivity to the space portion, even when the refractive index of the upper recording layer is set lower than that of the lower recording layer in order for the reflectivity of the upper recording layer to be lower than the reflectivity of the lower recording layer, a sufficiently large difference in reflectivity between the recording mark and the space portion can be obtained in the upper recording layer. In addition to this, by forming the upper recording layer such that the thickness thereof is the same as that of the lower recording layer or such that the thickness thereof is larger than that of the lower recording layer, a favorable recording mark having desirable characteristics can be formed in the upper recording layer.

Note that, even when the thickness of an upper recording layer placed relatively closer to the incident surface of the laser beam is equal to or larger than the thickness of a lower recording layer, by suppressing the extinction coefficient of the recording layers to a small value, for example, 0.35 or less, a laser beam projected onto the lower recording layer is absorbed less by the upper recording layer. Therefore, the reflectivity of the lower recording layer detected by a photodetector can be enhanced, and a favorable recording mark can be formed also in the lower recording layer.

Moreover, by configuring the recording layers such that the extinction coefficient of an upper recording layer is lower than that of a lower recording layer, the recording sensitivity of the lower recording layer and the reflectivity thereof detected by a photodetector can be made close to those of the upper recording layer. In addition to this, by forming the recording layers such that the thickness of an upper recording layer is the same as or larger than that of a lower recording layer, a favorable recording mark having desired characteristics can be formed in the upper recording layer.

As described above, in various exemplary embodiments of the present invention, at least an upper recording layer is composed of a material capable of forming a recording mark having an increased thickness larger than that of a space portion. Therefore, even if the refractive index of the upper recording layer is lower than that of a lower recording layer, a sufficiently large difference in reflectivity between the recording mark and the space portion can be obtained in the upper recording layer. Thus, various exemplary embodiments of the present invention are based on a concept totally different from that of the conventional technique.

Moreover, in various exemplary embodiments of the present invention, at least an upper recording layer is composed of a material capable of forming a recording mark having an increased thickness larger than that of a space portion, and the extinction coefficient of the upper recording layer is lower than that of a lower recording layer. Therefore, the recording sensitivity of the lower recording layer and the reflectivity thereof detected by a photodetector can be made close to the recording sensitivity of the upper recording layer and the reflectivity thereof detected by the photodetector. In addition to this, a favorable recording mark having desired characteristics can be formed in the upper recording layer. Thus, various exemplary embodiments of the present invention are based on a concept totally different from that of the conventional technique.

Accordingly, various exemplary embodiments of the present invention provide an optical recording medium comprising a plurality of recording layers in which a recording mark, having an increased thickness larger than the thickness of a neighboring space portion, is formed by an irradiation with a laser beam, wherein among the plurality of recording layers, a recording layer placed relatively closer to an incident surface of the laser beam has a refractive index lower than that of a recording layer placed farther away from the incident surface of the laser beam than the recording layer placed relatively closer to the incident surface of laser beam.

Moreover, various exemplary embodiments of the present invention provide an optical recording medium comprising a plurality of recording layers in which a recording mark, having an increased thickness larger than the thickness of a neighboring space portion, is formed by an irradiation with a laser beam, wherein among the plurality of recording layers, a recording layer placed relatively closer to an incident surface of a laser beam has an extinction coefficient lower than that of each recording layer placed farther away from the incident surface of the laser beam than the recording layer placed relatively closer to the incident surface of the laser beam.

In this application document, the expression that “the thicknesses of recording layers are the same” should mean that, in the state in which a recording mark is not formed, the difference in thickness between the thinnest and thickest recording layers is 10% or less of thickness of the thickest recording layer. Thus, the above expression is not limited to the case in which the thicknesses of the recording layers are exactly the same.

Furthermore, in this application document, the expression that “a recording layer essentially consists of Bi and O” should mean that the ratio of the total number of Bi and O atoms in the recording layer with respect to the number of all the atoms constituting the recording layer is 80% or more. When a recording layer essentially consists of Bi and O, the ratio of the total number of Bi and O atoms in the recording layer with respect to the number of all the atoms constituting the recording layer is preferably 90% or more. When a recording layer essentially consists of Bi and O, and when the ratio of the total number of Bi and O atoms in the recording layer with respect to the number of all the atoms constituting the recording layer is 80% or more, the recording layer may contain an additive element other than Bi and O. In this case, one or more additive elements may be added.

Moreover, the expression that “a recording layer essentially consists of Bi, O, and X” should mean that the ratio of the total number of Bi, O, and X atoms in the recording layer is 80% or more. When a recording layer essentially consists of Bi, O, and X, the ratio of the total number of Bi, O, and X atoms in the recording layer with respect to the number of all the atoms constituting the recording layer is preferably 90% or more.

According to various exemplary embodiments of the present invention, an optical recording medium can be implemented which has a plurality of recording layers, in which a favorable recording mark can be formed in any of the recording layers, and in which the recording mark can be reliably reproduced.

### BRIEF DESCRIPTION OF THE DRAWINGS

FIG. 1 is a graph showing the relationship between the thickness of recording layers of an optical recording medium according to a first exemplary embodiment of the present invention and the reflectivity of the recording layers with the refractive index of the recording layer as a parameter;

FIG. 2 is a cross-sectional side view schematically showing the structure in the vicinity of the recording layers of the optical recording medium;

FIG. 3 is a cross-sectional side view schematically showing the entire structure of the optical recording medium;

FIG. 4 is a cross-sectional side view schematically showing the entire structure of an optical recording medium according to a second exemplary embodiment of the present invention;

FIG. 5 is a cross-sectional side view schematically showing the entire structure of an optical recording medium according to a third exemplary embodiment of the present invention;

FIG. 6 is a graph showing the relationship between the thickness of a recording layer and the reflectivity thereof in a conventional optical recording medium; and

FIG. 7 is a graph showing the relationship between the thickness of recording layers and the reflectivity thereof in a conventional optical recording medium, with the refractive index of the recording layers as a parameter.

### DETAILED DESCRIPTION OF THE PREFERRED EMBODIMENTS

Hereinafter, preferred exemplary embodiments of the present invention will be described in detail with reference to the drawings.

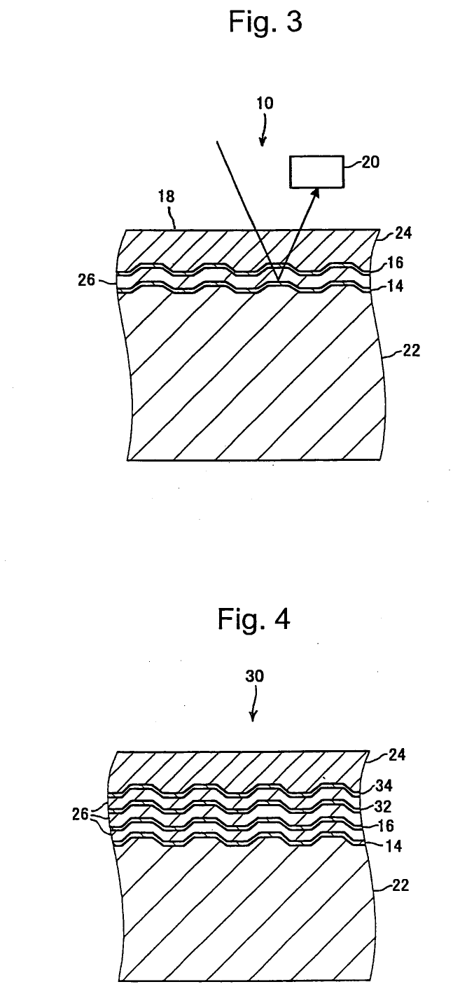

An optical recording medium 10 according to a first exemplary embodiment of the present invention has a disc-like shape having an outer diameter of about 120 mm and a thickness of about 1.2 mm. As shown in FIGS. 2 and 3, the optical recording medium 10 comprises a first recording layer 14 and a second recording layer 16. In the first recording layer 14 and the second recording layer 16, a recording mark 12 having an increased thickness larger than that of a neighboring space portion 11 is formed by an irradiation with a laser beam. The optical recording medium 10 is characterized in that the refractive index n₂ of the second recording layer 16 placed relatively closer to an incident surface 18 of the laser beam is smaller than the refractive index n₁ of the first recording layer 14 placed farther away from the incident surface 18 of the laser beam than the second recording layer 16. The other components are the same as or similar to those of a conventional optical recording medium. Thus, a description for the other components will be appropriately omitted since it may not be particularly important to understand the first exemplary embodiment of the present invention.

The first recording layer 14 and the second recording layer 16 essentially consist of Bi and O, and the ratio of the number of O atoms in each of the first recording layer 14 and the second recording layer 16 is 62% or more. Furthermore, the ratio of the number of O atoms in each of the first recording layers 14 and the second recording layer 16 is preferably 73% or less. The material for the second recording layer 16 contains at least one element selected from among Mg, Al, Si, V, Zn, Ge, Y, Sn, Sb, and Dy. Hence, the refractive index n₂ of the second recording layer 16 is set lower than the refractive index n₁ of the first recording layer 14. Furthermore, by adding these elements, the extinction coefficient of the second recording layer 16 is decreased, and thus the effect of increasing the amount of a laser beam reaching the first recording layer 14 can be obtained.

As described above, by adding an element other than Bi and O to reduce the extinction coefficient of the second recording layer 16, the reflectivity of the first recording layer 14 onto which a laser beam is projected through the second recording layer 16 can be made close to the reflectivity of the second recording layer 16. In addition to this, the recording sensitivity of the first recording layer 14 can be made close to the recording sensitivity of the second recording layer 16. Moreover, by employing, as the material for the first recording layer 14, a material essentially consisting of Bi and O and further containing at least one element selected from among Fe, Cu, Mo, Ag, W, Ir, Pt, and Au, the extinction coefficient of the first recording layer 14 can be enhanced to improve the recording sensitivity of the first recording layer 14 (a recording mark can be more easily formed in the first recording layer 14). Hence, the recording sensitivity of the first recording layer 14 can be made close to the recording sensitivity of the second recording layer 16.

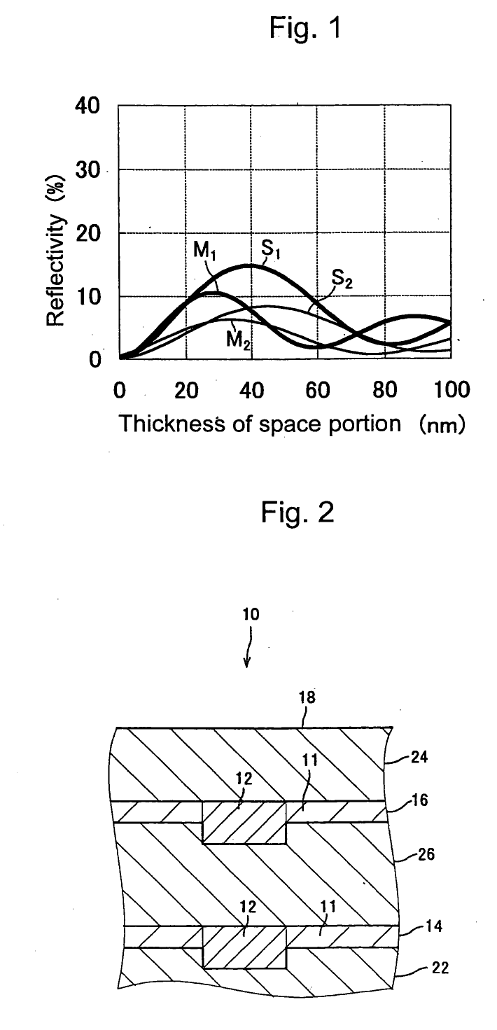

The relationship between the reflectivity and the thickness of each of the first recording layer 14 and the second recording layer 16 composed of the above materials is shown in FIG. 1 as curves designated by the symbols S₁, S₂, M₁, and M₂. The reflectivity shown in FIG. 1 is the reflectivity of the recording layer itself (the reflectivity in bare condition). Although the reflectivity of the second recording layer 16 is approximately the same as the reflectivity detected by a photodetector 20, the reflectivity of the first recording layer 14 is higher than the reflectivity detected by a photodetector 20. The materials for the first recording layer 14 and the second recording layer 16, respectively, have characteristics that the reflectivity of the space portion 11 reaches maximum at a predetermined thickness (about 40 nm in the first exemplary embodiment), as shown in FIG. 1.

Each of the first recording layer 14 and the second recording layer 16 is formed in a thickness of about 45 nm which is approximately the same as the thickness giving a maximum reflectivity to the space portion 11. As described above, the refractive index n₂ of the second recording layer 16 is lower than the refractive index n₁ of the first recording layer 14. Hence, for both the space portion 11 and the recording mark 12, the reflectivity of the second recording layer 16 is lower than the reflectivity of the first recording layer 14. The refractive index n₂ of the second recording layer 16 is lower than the refractive index n₁ of the first recording layer 14 by preferably 0.1 to 0.6 and more preferably 0.2 to 0.5.

Furthermore, the first recording layer 14 and the second recording layer 16 have an extinction coefficient of 0.35 or less. The extinction coefficient of the second recording layer 16 is lower than the extinction coefficient of the first recording layer 14 by preferably 0.01 to 0.20 and more preferably 0.02 to 0.14.

The first recording layer 14 and the second recording layer 16 are formed over a substrate 22. Over the second recording layer 16, a cover layer 24 is formed on the side opposite to the substrate 22. Furthermore, a spacer layer 26 is formed between the first recording layer 14 and the second recording layer 16.

The substrate 22 has a thickness of about 1.1 mm, and a concavo-convex pattern constituting a groove is formed on its surface on the side of the cover layer 24. Generally, the term “groove” means a recessed portion employed for recording and reproducing data. However, in this application document, even if a portion employed for recording and reproducing data is a projecting portion which projects toward the cover layer 24, the term “groove” is employed for the projecting portion for convenience. In the first exemplary embodiment, a projecting portion projecting toward the cover layer 24 is the groove. Examples of the material for the substrate 22 include a polycarbonate resin, an acrylic resin, an epoxy resin, a polystyrene resin, a polyethylene resin, a polypropylene resin, a silicone resin, a fluororesin, an ABS resin, a urethane resin, or the like.

The cover layer 24 has a thickness of, for example, 30 to 150 μm. The material for the cover layer 24 may include an energy beam-curable transparent resin such as an acrylic UV-curable resin or an epoxy UV-curable resin. As used herein, the term “energy beam” is used as a generic name for an electromagnetic wave and a particle beam such as an ultraviolet ray and an electron beam which have characteristics capable of curing a particular resin in a fluid state. As a method for forming the cover layer 24 from a material therefor, a resin having flowability may be applied on a substrate, and then an energy beam may be projected thereonto for curing. Furthermore, a transparent film prepared in advance may be applied on a substrate.

The spacer layer 26 has a thickness of, for example, about 5 to about 90 μm, and both the surfaces thereof have a concavo-convex pattern of grooves similar to that of the substrate 22. Here, examples of the material for the spacer layer 26 include an energy beam-curable translucent resin such as an acrylic UV-curable resin or an epoxy UV-curable resin as in the cover layer 24.

The first recording layer 14 is formed in a concavo-convex pattern following the concavo-convex pattern of the substrate 22. The second recording layer 16 is also formed in a concavo-convex pattern following the concavo-convex pattern of the spacer layer 26.

Next, a description will be given of the operation of the optical recording medium 10.

In the optical recording medium 10, a laser beam is projected onto the first recording layer 14 and the second recording layer 16 to thereby form the recording mark 12 having an increased thickness larger than that of the neighboring space portion 11. Thus, as shown in FIG. 1, the difference in reflectivity between the space portion 11 and the recording mark 12 is large at around the thickness giving maximum reflectivity to the space portion 11 and in a region in which the thickness is larger than the above thickness. Specifically, the first recording layer 14 and the second recording layer 16 are formed to have a thickness close to the thickness giving the maximum reflectivity to the space portion 11. In addition to this, the refractive index of the second recording layer 16 is set lower than that of the first recording layer 14 in order for the reflectivity of the second recording layer 16 to be lower than the reflectivity of the first recording layer 14. Irrespective of the above settings, a sufficient difference in reflectivity between the recording mark 12 and the space portion 11 is obtained in the second recording layer 16. Additionally, since the second recording layer 16 has the same thickness as that of the first recording layer 14, a favorable recording mark having desired characteristics can be formed in the second recording layer 16.

Furthermore, since the extinction coefficient of the second recording layer 16 is 0.35 or less, even when the second recording layer 16 has the same thickness as that of the first recording layer 14, a laser beam projected onto the first recording layer 14 is less absorbed by the second recording layer 16. Hence, the reflectivity of the first recording layer 14 detected by the photodetector 20 can be increased, and a favorable recording mark can be formed also in the first recording layer 14.

Next, a description will be given of a second exemplary embodiment of the present invention.

As shown in FIG. 4, an optical recording medium 30 according to the second exemplary embodiment of the present invention has four recording layer. In addition to the first recording layer 14 and the second recording layer 16 in the optical recording medium 10 according to the first exemplary embodiment, the optical recording medium 30 comprises a third recording layer 32 and a fourth recording layer 34. Since the other components are the same as those of the first exemplary embodiment, the same numerals as those employed in the first exemplary embodiment are employed for the same components, and the descriptions thereof will be omitted as appropriate.

The first recording layer 14, the second recording layer 16, the third recording layer 32, and the fourth recording layer 34 have the same thickness and are arranged in this order along the direction from the substrate 22 to the incident surface 18 of the laser beam. The spacer layers 26 are placed between the first and second recording layers 14 and 16, between the second and third recording layers 16 and 32, and between the third and fourth recording layers 32 and 34, respectively. The fourth recording layer 34 contacts the cover layer 24.

The materials for the third recording layer 32 and the fourth recording layer 34 are essentially consist of Bi and O as in the materials for the first recording layer 14 and the second recording layer 16. The ratio of the number of O atoms in each of the third recording layers 32 and the fourth recording layer 34 is 62% or more.

The refractive index n₃ of the third recording layer 32 is lower than the refractive index n₂ of the second recording layer 16, and the refractive index n₄ of the fourth recording layer 34 is lower than the refractive index n₃ of the third recording layer 32. That is, the optical recording medium 30 has a configuration in which the refractive indices of the first to fourth recording layers 14, 16, 32, and 34 satisfy the relation n₁>n₂>n₃>n₄. Hence, in the optical recording medium 30, the reflectivities of the recording layers (the reflectivities in bare condition) increase in the direction from the incident surface 18 of the laser beam to the substrate 22, i.e., in the order of the fourth recording layer 34, the third recording layer 32, the second recording layer 16, and the first recording layer 14.

As in the optical recording medium 10, in the optical recording medium 30, a laser beam is projected onto the first to fourth recording layers 14, 16, 32, and 34 to thereby form the recording mark 12 having an increased thickness larger than that of the neighboring space portion 11. Therefore, the difference in reflectivity between the space portion 11 and the recording mark 12 is large at around the thickness giving the maximum reflectivity to the space portion 11 and in the region in which the thickness is larger than the above thickness. Specifically, each of the first to fourth recording layers 14, 16, 32, and 34 is formed to have a thickness close to the thickness giving the maximum reflectivity to the space portion 11. In addition to this, the refractive indices n₂, n₃, and n₄ of the second, third, and fourth recording layers 16, 32, and 34, respectively, are set lower than the refractive index n₁ of the first recording layer 14 in order for the reflectivities of the second, third, and fourth recording layers, 16, 32, and 34 to be lower than the reflectivity of the first recording layer 14. Irrespective of the above settings, a sufficient difference in reflectivity between the recording mark 12 and the space portion 11 is obtained in the second, third, and fourth recording layers 16, 32, and 34. In addition to this, since the second, third, and fourth recording layers 16, 32, and 34 have the same thickness as that of the first recording layer 14, a favorable recording mark having desired characteristics can be formed in the second, third, and fourth recording layers 16, 32, and 34.

Furthermore, since the extinction coefficient of each of the second, third, and fourth recording layers 16, 32, and 34, is 0.35 or less, even when the second, third, and fourth recording layers 16, 32, and 34 have the same thickness as that of the first recording layer 14, laser beams projected onto the first, second, and third recording layers 14, 16, and 32 are less absorbed by the second, third, and fourth recording layers 16, 32, and 34. Hence, the reflectivity of each of the first to third recording layers 14, 16, and 32 detected by the photodetector 20 can be increased, and a favorable recording mark can be formed also in the first to third recording layers 14, 16 and 32.

Next, a description will be given of a third exemplary embodiment of the present invention.

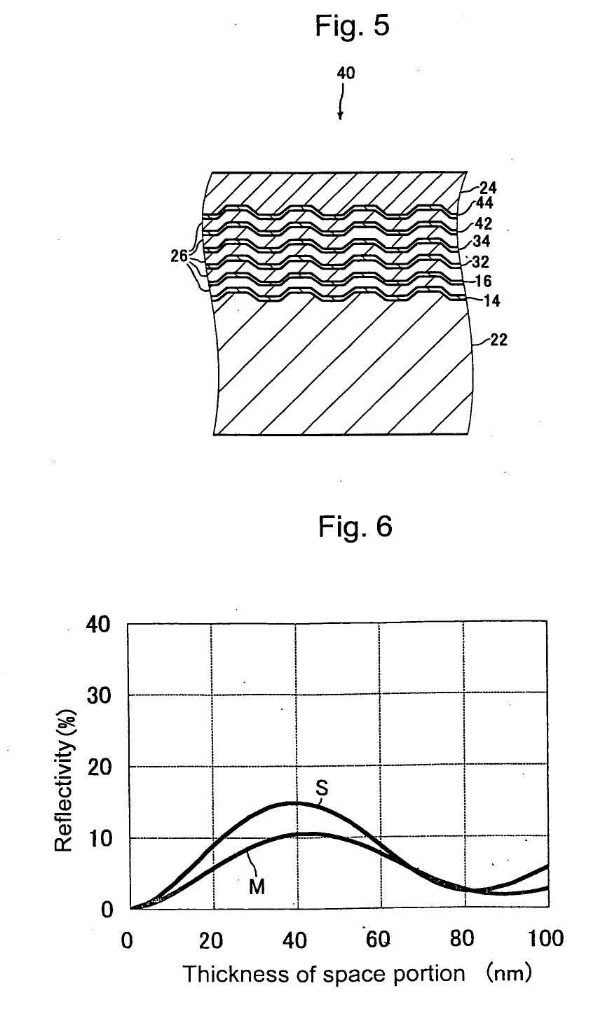

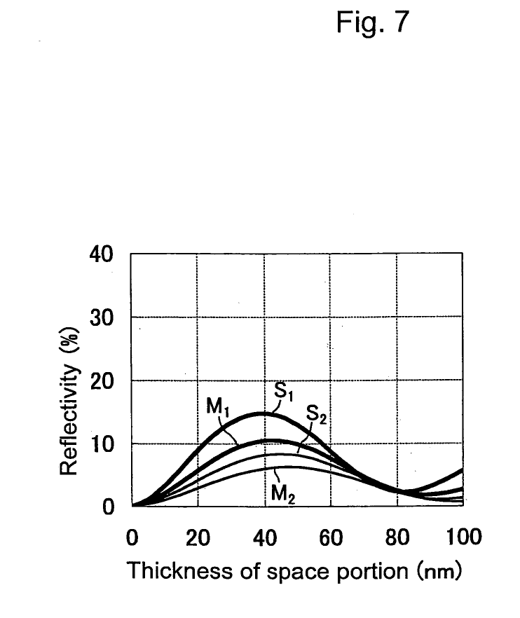

As shown in FIG. 5, an optical recording medium 40 according to the third exemplary embodiment is a six-layer recording type. In addition to the first to fourth recording layers 14, 16, 32, and 34 in the optical recording medium 30 according to the second exemplary embodiment, the optical recording medium 40 comprises a fifth recording layer 42 and a sixth recording layer 44. Since the other components are the same as those of the first and second exemplary embodiments, the same numerals as those employed in the first and second exemplary embodiments are employed for the same components, and the descriptions will be omitted as appropriate.

The first recording layer 14, the second recording layer 16, the third recording layer 32, the fourth recording layer 34, the fifth recording layer 42, and the sixth recording layer 44 have the same thickness, and arranged in this order along the direction from the substrate 22 to the incident surface 18 of the laser beam. The spacer layers 26 are placed between the first and second recording layers 14 and 16, between the second and third recording layers 16 and 32, between the third and fourth recording layers 32 and 34, between the fourth and fifth recording layers 34 and 42, and between the fifth and sixth recording layers 42 and 44, respectively. The sixth recording layer 44 contacts the cover layer 24.

The materials for the fifth and sixth recording layers 42 and 44 essentially consist of Bi and O as in the materials for the first and second recording layers 14 and 16. The ratio of the number of O atoms in each of the fifth and sixth recording layers 42 and 44 is 62% or more.

The refractive index n₅ of the fifth recording layer 42 is lower than the refractive index n₄ of the fourth recording layer 34, and the refractive index n₆ of the sixth recording layer 44 is lower than the refractive index n₅ of the fifth recording layer 42. That is, the optical recording medium 40 has a configuration in which the refractive indices of the first to sixth recording layers 14, 16, 32, 34, 42, and 44 satisfy the relation n₁>n₂>n₃>n₄>n₅>n₆. Hence, in the optical recording medium 40, the reflectivities of the recording layers (the reflectivities in bare condition) increase in the direction from the incident surface 18 of the laser beam to the substrate 22, i.e., in the order of the sixth recording layer 44, the fifth recording layer 42, the fourth recording layer 34, the third recording layer 32, the second recording layer 16, and the first recording layer 14.

As in the optical recording medium 10, in the optical recording medium 40, a laser beam is projected onto the first to sixth recording layers 14, 16, 32, 34, 42, and 44 to thereby form the recording mark 12 having an increased thickness larger than that of the neighboring space portion 11. Therefore, the difference in reflectivity between the space portion 11 and the recording mark 12 is large at around the thickness giving the maximum reflectivity to the space portion 11 and in a region in which the thickness is larger than the above thickness. Specifically, each of the first to sixth recording layers 14, 16, 32, 34, 42, and 44 is formed to have a thickness close to the thickness giving the maximum reflectivity to the space portion 11. In addition to this, the refractive indices n₂, n₃, n₄, n₅, and n₆ of the second to sixth recording layers 16, 32, 34, 42, and 44, respectively, are set lower than the refractive index n₁ of the first recording layer 14 in order for the reflectivities of the second to sixth recording layers, 16, 32, 34, 42, and 44 to be lower than the reflectivity of the first recording layer 14. Irrespective of the above settings, a sufficient difference in reflectivity between the recording mark 12 and the space portion 11 is obtained in the second to sixth recording layers 16, 32, 34, 42 and 44. In addition to this, since the second to sixth recording layers 16, 32, 34, 42, and 44 have the same thickness as that of the first recording layer 14, a favorable recording mark having desired characteristics can be formed in the second to sixth recording layers 16, 32, 34, 42, and 44.

Furthermore, since the extinction coefficient of each of the second to sixth recording layers 16, 32, 34, 42, and 44 is 0.35 or less, even when the second to sixth recording layers 16, 32, 34, 42, and 44 have the same thickness as that of the first recording layer 14, laser beams projected onto the first to fifth recording layers 14, 16, 32, 34, and 42 are less absorbed by the second to sixth recording layers 16, 32, 34, 42, and 44. Hence, the reflectivity of each of the first to fifth recording layers 14, 16, 32, 34, and 42 detected by the photodetector 20 can be enhanced, and a favorable recording mark can be formed also in the first to fifth recording layers 14, 16, 32, 34, and 42.

Incidentally, in the first to third exemplary embodiments described above, each of the first to sixth recording layers 14, 16, 32, 34, 42, and 44 is formed to a thickness which is approximately the same as the thickness giving the maximum reflectivity to the space portion 11. However, so long as a sufficient difference in reflectivity between the recording mark 12 and the space portion 11 can be obtained in the first to sixth recording layers 14, 16, 32, 34, 42, and 44, and so long as the reflectivities of the recording layers themselves (the reflectivities in bare condition) increase in the direction from the side of the incident surface 18 of the laser beam to the side of the substrate 22, the thickness of each of the first to sixth recording layers 14, 16, 32, 34, 42, and 44 may be larger or smaller than the thickness giving the maximum reflectivity. However, it is preferable that the recording layers be formed in a thickness larger than the thickness giving the maximum reflectivity since the difference in reflectivity between the recording mark 12 and the space portion 11 can be increased and the recording sensitivity can be improved.

Furthermore, in the first to third exemplary embodiments described above, the materials for the first to sixth recording layers 14, 16, 32, 34, 42, and 44 are a material which gives the maximum reflectivity to the space portion 11 at a thickness of about 40 nm. However, a material which gives the maximum reflectivity to the space portion 11 at a thickness of more than 40 nm or at a thickness of less than 40 nm may be employed as the materials for the first to sixth recording layers. 14, 16, 32, 34, 42, and 44.

Moreover, in the first to third exemplary embodiments described above, the first to sixth recording layers 14, 16, 32, 34, 42, and 44 have the same thickness. However, among these recording layers, a recording layer placed relatively closer to the incident surface 18 of the laser beam may have a larger thickness than that of a recording layer placed farther from the incident surface 18 of the laser beam than the above recording layer placed relatively closer to the incident surface 18 of the laser beam. By forming the recording layer placed relatively closer to the incident surface 18 of the laser beam to have a larger thickness, the recording sensitivity thereof can be improved.

Furthermore, in the first to third exemplary embodiments described above, the materials for the first to sixth recording layers 14, 16, 32, 34, 42, and 44 are a material essentially consisting of Bi and O. However, any other material may be employed as the materials for the first to sixth recording layers 14, 16, 32, 34, 42, and 44 so long as a recording mark having an increased thickness larger than a neighboring space portion can be formed by an irradiation with a laser beam. Also in this case, preferably, a material having an extinction coefficient of 0.35 or less is employed. For example, a material containing Bi, Ge, and N may be employed.

Moreover, in the first to third exemplary embodiments described above, the first to sixth recording layers 14, 16, 32, 34, 42, and 44 contain common elements (Bi and O). However, the first recording layer 14 may not contain elements in common with the second to sixth recording layers 16, 32, 34, 42, and 44. For example, a material having an extinction coefficient of more than 0.35 may be employed as the material for the first recording layer 14. Moreover, as the material for the first recording layer 14, a material may be employed in which a recording mark having an increased thickness larger than that of the neighboring space portion is not formed by an irradiation with a laser beam.

Furthermore, in the second exemplary embodiment described above, the optical recording medium 30 is configured such that the refractive indices of the recording layers decrease in the direction from the substrate 22 to the laser beam incident surface 18, i.e., in the order of the first recording layer 14, the second recording layer 16, the third recording layer 32, and the fourth recording layer 34. Therefore, the optical recording medium 30 is configured such that the reflectivities of the recording layers (the reflectivities in bare condition) increase in the direction from the incident surface 18 of the laser beam to the substrate 22, i.e., in the order of the fourth recording layer 34, the third recording layer 32, the second recording layer 16, and the first recording layer 14. In the third exemplary embodiment described above, the optical recording medium 40 is configured such that the refractive indices of the recording layers decrease in the direction from the substrate 22 to the laser beam incident surface 18, i.e., in the order of the first recording layer 14, the second recording layer 16, the third recording layer 32, the fourth recording layer 34, the fifth recording layer 42, and the sixth recording layer 44. Therefore, the optical recording medium 40 is configured such that the reflectivities of the recording layers (the reflectivities in bare condition) increase in the direction from the incident surface 18 of the laser beam to the substrate 22, i.e., in the order of the sixth recording layer 44, the fifth recording layer 42, the fourth recording layer 34, the third recording layer 32, the second recording layer 16, and the first recording layer 14. However, so long as, in a pair of any two of these layers, an upper recording layer placed relatively closer to the incident surface 18 of the laser beam has a lower refractive index than that of a lower recording layer placed farther from the incident surface 18 of the laser beam than the upper recording layer, this relation for the refractive index is not necessarily satisfied in the other pairs. Also in this case, a certain effect can be obtained in which the differences in the reflectivity detected by the photodetector between these recording layers can be reduced.

Furthermore, in FIG. 2 in the first exemplary embodiment described above, the recording mark 12 has a shape having a uniform thickness from end to end. However, no particular limitation is imposed on the shape of the recording mark, so long as at least a part of the shape of the recording mark has a thickness larger than that of a neighboring space portion. The recording mark may have a shape in which the entire portion has a thickness larger than that of a neighboring space portion and the thickness varies according to position. Furthermore, the recording mark may have a shape in which a part thereof is thicker than a neighboring space portion and the rest thereof has the same thickness as that of the space portion. For example, a shape may be employed in which the thickness is the largest at around the center and decreases as the distance from the center increases. In actual cases, a recording mark having such a shape is often formed. The thickness of a recording mark can be determined at various positions by observing the cross-section of the recording mark by TEM (Transmission Electron Microscopy).

Moreover, in the first to third exemplary embodiments described above, the optical recording media 10, 30, and 40 are configured such that each of the first to sixth recording layers 14, 16, 32, 34, 42, and 44 directly contact the substrate 22, the cover layer 24, or the spacer layer 26. However, for example, a reflective layer may be provided between the first recording layer 14 and the substrate 22. Examples of the material for the reflective layer include Al, Ag, Au, Cu, Mg, Ti, Cr, Fe, Co, Ni, Zn, Ge, Pt, Pd, and alloys thereof. Of these, Al, Ag, Au, Cu, and an alloy such as AgPdCu is preferably employed since high reflectivity can obtained. Furthermore, a dielectric material can be employed as the material for the reflection layer. Moreover, a dielectric layer may be provided on one or both sides of a part or all of the recording layers. Examples of the material for the dielectric layer include oxides such as SiO₂, Al₂O₃, ZnO, CeO₂, Ta₂O₅, and TiO₂, nitrides such as SiN, AlN, GeN, and GeCrN, sulfides such as ZnS, and materials containing a combination thereof as main components such as a mixture of ZnS and SiO₂.

Furthermore, in the first exemplary embodiment described above, the optical recording medium 10 is configured such that the refractive index n₂ of the second recording layer 16 placed relatively closer to the incident surface 18 of the laser beam is lower than the refractive index n₁ of the first recording layer 14 placed farther from the incident surface 18 of the laser beam than the second recording layer 16. In the second exemplary embodiment described above, the optical recording medium 30 is configured such that the refractive indices of the first to fourth recording layers 14, 16, 32, and 34 satisfy the relation n₁>n₂>n₃>n₄. In the third exemplary embodiment described above, the optical recording medium 40 is configured such that the refractive indices of the first to sixth recording layers 14, 16, 32, 34, 42, and 44 satisfy the relation n₁>n₂>n₃>n₄>n₅>n₆. However, the refractive indices of the recording layers do not necessarily satisfy the above relations, so long as an optical recording medium has a plurality of recording layers in which a recording mark, having an increased thickness larger than that of a neighboring space portion, is formed by an irradiation with a laser beam and the extinction coefficient of a recording layer placed relatively closer to an incident surface of a laser beam can be set lower than the extinction coefficient of a recording layer placed farther from the incident surface of the laser beam than the abovementioned recording layer placed relatively closer to the incident surface. If this configuration is employed, the recording sensitivity of the lower recording layer and the reflectivity thereof detected by a photodetector can be made close to those of the upper recording layer. In addition to this, a favorable recording mark having desired characteristics can be formed in the upper recording layer.

In the first exemplary embodiment described above, the optical recording medium 10 has two recording layers, and, in the second exemplary embodiment, the optical recording medium 30 has four recording layers. Furthermore, in the third exemplary embodiment, the optical recording medium 40 has six recording layers. However, the present invention is suitable for an optical recording medium having three, five, seven, or even more recording layers.

Moreover, in the first to third exemplary embodiments described above, the optical recording media 10, 30, 40 are a single-sided recording type in which the recording layers are provided in one side. However, of course, the present invention is applicable to an optical recording medium of a double-sided recording type in which the recording layers are provided in both sides.

Furthermore, in the first to third exemplary embodiments described above, the optical recording media 10, 30, and 40 are configured such that the cover layer 24 is thinner than the substrate 22. However, of course, the present invention is applicable to an optical recording medium in which a substrate and a cover layer have the same thickness as in a DVD. In this case, the substrate and the cover layer have approximately the same shape. However, in the present application document, the cover layer refers to a layer irradiated with a recording-reproducing laser beam.

### WORKING EXAMPLE 1

14 optical recording media each having two recording layers were prepared which had the same configuration as that of the optical recording medium 10 of the above first exemplary embodiment. In these 14 optical recording media, the compositions of the second recording layer 16 are different, and the components other than the second recording layer 16 are the same.

Specifically, materials containing Bi and O were employed as the materials for the first recording layer 14 and the second recording layer 16. The ratio of the number of O atoms in the first recording layer 14 was 68%, and the ratio of the number of Bi atoms was 32%. Other elements were not added. On the other hand, Si, Al, Mg, V, Zn, Ge, Y, Sn, Sb, or Dy was added to the second recording layer 16 so that the refractive index thereof was lower than that of the first recording layer 14. Each of the first recording layer 14 and the second recording layer 16 was formed in a thickness of about 45 nm which is close to a thickness giving a maximum reflectivity to these materials.

These 14 optical recording media were measured for the refractive index, the extinction coefficient, the reflectivity (of an unrecorded portion), the recording sensitivity, and the 8T C/N value of each of the first recording layer 14 and the second recording layer 16. The measurement results are shown in Table 1. In addition to this, the compositions and the deposition conditions for the first recording layer 14 and the second recording layer 16 are also listed in Table 1. The recording sensitivity was determined as follows. First, each of the optical recording media was irradiated with a laser beam at various powers to form the recording marks 12. Next, a jitter value of each of the recording marks 12 was determined by means of a recording-reproducing, apparatus. A laser beam power employed for forming the recording mark 12 having the smallest jitter value is suitable for a laser beam power for the optical recording medium. Thus, this laser beam power was employed as the recording sensitivity. Here, the laser beam power is represented by converting the intensity of the laser beam reaching the incident surface 18 to electric power. The lower the laser beam power giving the recording sensitivity, the more easily the recording mark can be formed and the higher the recording sensitivity. The reflectivity of each of the first recording layer 14 and the second recording layer 16 shown in Table 1 was obtained as follows. First, each of the recording layers was irradiated with a recording laser beam having a power corresponding to the recording sensitivity of the recording layer to form a recording mark 12. Subsequently, a reproducing laser beam was projected onto the formed recording mark 12, and the reflectivity was detected by the photodetector 20. Here, the powers of the reproducing laser beams projected onto the first recording layer 14 and the second recording layer 16 were the same.

TABLE 1

| | | | | | | | | | Deposition conditions | | | |
|---|---|---|---|---|---|---|---|---|---|---|---|---|
| | | | | | | | | | | | Gas flow | |
| | | | Recording | | | | | | Deposition | | rate | |
| | Refractive | Reflectivity | sensitivity | 8T C/N | Extinction | Composition(at %) | | | power (W) | | (sccm) | |
| | index | (%) | (mW) | (dB) | coefficient k | Bi | X | O | Bi | X | Ar | O₂ |
| Second recording layer | 1.8 | 3.9 | 11.0 | 52 | 0.08 | 21 | 9(Si) | 70 | 75 | 800 | 50 | 9 |
| First recording layer | 2.4 | 7.1 | 6.0 | 55 | 0.16 | 32 | 0 | 68 | 200 | — | 50 | 15 |
| Second recording layer | 1.9 | 4.5 | 9.0 | 56 | 0.09 | 22 | 8(Si) | 70 | 75 | 600 | 50 | 9 |
| First recording layer | 2.4 | 6.6 | 6.0 | 55 | 0.16 | 32 | 0 | 68 | 200 | — | 50 | 15 |
| Second recording layer | 2.1 | 6.1 | 7.5 | 58 | 0.11 | 25 | 6(Si) | 69 | 100 | 600 | 50 | 10 |
| First recording layer | 2.4 | 6.3 | 6.5 | 55 | 0.16 | 32 | 0 | 68 | 200 | — | 50 | 15 |
| Second recording layer | 2.2 | 8.0 | 6.5 | 57 | 0.13 | 27 | 4(Si) | 69 | 200 | 600 | 50 | 15 |
| First recording layer | 2.4 | 6.0 | 7.0 | 55 | 0.16 | 32 | 0 | 68 | 200 | — | 50 | 15 |
| Second recording layer | 2.3 | 9.8 | 6.0 | 56 | 0.14 | 30 | 2(Si) | 68 | 200 | 300 | 50 | 15 |
| First recording layer | 2.4 | 5.8 | 7.5 | 55 | 0.16 | 32 | 0 | 68 | 200 | — | 50 | 20 |
| Second recording layer | 2.2 | 8.4 | 7.5 | 56 | 0.12 | 27 | 5(Al) | 68 | 200 | 800 | 50 | 13 |
| First recording layer | 2.4 | 6.1 | 6.5 | 55 | 0.16 | 32 | 0 | 68 | 200 | — | 50 | 15 |
| Second recording layer | 2.2 | 8.3 | 7.0 | 55 | 0.13 | 22 | 14(Mg) | 64 | 200 | 800 | 50 | 15 |
| First recording layer | 2.4 | 6.2 | 6.5 | 55 | 0.16 | 32 | 0 | 68 | 200 | — | 50 | 15 |
| Second recording layer | 2.3 | 9.8 | 7.0 | 56 | 0.14 | 29 | 4(V) | 67 | 200 | 400 | 50 | 13 |
| First recording layer | 2.4 | 5.9 | 6.0 | 55 | 0.16 | 32 | 0 | 68 | 200 | — | 50 | 15 |
| Second recording layer | 2.2 | 7.5 | 7.5 | 53 | 0.12 | 24 | 8(Zn) | 68 | 200 | 600 | 50 | 20 |
| First recording layer | 2.4 | 6.0 | 6.5 | 55 | 0.16 | 32 | 0 | 68 | 200 | — | 50 | 15 |
| Second recording layer | 2.2 | 7.1 | 8.5 | 56 | 0.12 | 26 | 4(Ge) | 70 | 100 | 150 | 50 | 12 |
| First recording layer | 2.4 | 6.3 | 6.0 | 55 | 0.16 | 32 | 0 | 68 | 200 | — | 50 | 15 |
| Second recording layer | 2.3 | 9.0 | 7.5 | 56 | 0.13 | 27 | 3(Y) | 70 | 150 | 600 | 50 | 15 |
| First recording layer | 2.4 | 6.0 | 6.5 | 55 | 0.16 | 32 | 0 | 68 | 200 | — | 50 | 15 |
| Second recording layer | 2.1 | 7.1 | 7.0 | 51 | 0.13 | 25 | 8(Sn) | 67 | 200 | 200 | 50 | 18 |
| First recording layer | 2.4 | 6.0 | 7.0 | 55 | 0.16 | 32 | 0 | 68 | 200 | — | 50 | 15 |
| Second recording layer | 2.2 | 8.8 | 6.0 | 56 | 0.13 | 23 | 5(Sb) | 72 | 200 | 200 | 50 | 20 |
| First recording layer | 2.4 | 6.1 | 7.0 | 55 | 0.16 | 32 | 0 | 68 | 200 | — | 50 | 15 |
| Second recording layer | 2.2 | 8.4 | 7.0 | 55 | 0.14 | 26 | 5(Dy) | 69 | 150 | 600 | 50 | 15 |
| First recording layer | 2.4 | 6.2 | 7.0 | 55 | 0.16 | 32 | 0 | 68 | 200 | — | 50 | 15 |

### WORKING EXAMPLE 2

One optical recording medium having two recording layers was prepared in which Fe was added to the first recording layer 14 in contrast to Working Example 1, and Al was added to the second recording layer 16. Each of the first recording layer 14 and the second recording layer 16 was formed to a thickness of about 55 nm. The other components were the same as those of Working Example 1.

This optical recording medium was measured for the refractive index, the extinction coefficient, the reflectivity, the recording sensitivity, and the 8T C/N value of each of the first recording layer 14 and the second recording layer 16. The measurement results are shown in Table 2. In addition to this, the compositions and the deposition conditions for the first recording layer 14 and the second recording layer 16 are also listed in Table 2.

TABLE 2

| | | | | | | | | | Deposition conditions | | | |
|---|---|---|---|---|---|---|---|---|---|---|---|---|
| | | | | | | | | | Deposition | | Gas flow | |
| | | | Recording | | | | | | power | | rate | |
| | Refractive | Reflectivity | sensitivity | 8T C/N | Extinction | Composition(at %) | | | (W) | | (sccm) | |
| | index | (%) | (mW) | (dB) | coefficient k | Bi | X | O | Bi | X | Ar | O₂ |
| Second recording layer | 2.1 | 6.5 | 7.5 | 57 | 0.11 | 25 | 7(Al) | 68 | 150 | 800 | 50 | 13 |
| First recording layer | 2.3 | 4.0 | 5.0 | 57 | 0.25 | 27 | 6(Fe) | 67 | 200 | 400 | 50 | 15 |

### WORKING EXAMPLE 3

An optical recording medium having four recording layers as in the optical recording medium 30 of the above second exemplary embodiment was prepared. The optical recording medium was configured such that the thicknesses of the recording layers increase in the order of the first recording layer 14, the second recording layer 16, the third recording layer 32, and the fourth recording layer 34.

Specifically, materials containing Bi, O, and Ge were employed as the materials for the first to fourth recording layers 14, 16, 32, and 34. One optical recording medium was prepared in which the atomic ratios of Bi, O, Ge are different in each of the first to fourth recording layers 14, 16, 32, and 34. The first recording layer 14 was formed in a thickness of 48 nm which is close to a thickness giving a maximum reflectivity to the material therefor. Furthermore, the second recording layer 16, the third recording layer 32, and the fourth recording layer 34 were formed in thicknesses larger than the thickness of the first recording layer 14, i.e., thicknesses of 62 nm, 68 nm, and 73 nm, respectively.

This optical recording medium was measured for the refractive index, the extinction coefficient, the reflectivity, the recording sensitivity, and the 8T C/N value of each of the first to fourth recording layers 14, 16, 32, and 34. The measurement results are shown in Table 3. In addition to this, the compositions and the deposition conditions for the first to fourth recording layers 14, 16, 32, and 34 are also listed in Table 3.

TABLE 3

| | | | | | | | | | | Deposition conditions | | | |
|---|---|---|---|---|---|---|---|---|---|---|---|---|---|
| | | | | | | | | | | Deposition | | Gas flow | |
| | | | | Recording | | | Composition | | | power | | rate | |
| | Refractive | Thickness | Reflectivity | sensitivity | 8T C/N | Extinction | (at %) | | | (W) | | (sccm) | |
| | index | (nm) | (%) | (mW) | (dB) | coefficient k | Bi | O | Ge | Bi | Ge | Ar | O₂ |
| Fourth recording layer | 2.0 | 73 | 3.5 | 9.0 | 58 | 0.09 | 23 | 68 | 9 | 75 | 200 | 50 | 12 |
| Third recording layer | 2.1 | 68 | 4.1 | 9.0 | 55 | 0.11 | 25 | 68 | 7 | 85 | 200 | 50 | 12 |
| Second recording layer | 2.2 | 62 | 3.5 | 10.0 | 55 | 0.13 | 25 | 71 | 4 | 100 | 150 | 50 | 12 |
| First recording layer | 2.4 | 48 | 3.5 | 9.0 | 56 | 0.15 | 29 | 70 | 1 | 100 | 100 | 50 | 14 |

### WORKING EXAMPLE 4

An optical recording medium having six recording layers was prepared as in the optical recording medium 40 of the above third exemplary embodiment. The optical recording medium was configured such that the thicknesses of the recording layers increase in the order of the first recording layer 14, the second recording layer 16, the third recording layer 32, the fourth recording layer 34, the fifth recording layer 42, and the sixth recording layer 44.

Specifically, the first recording layer 14 has a configuration in which a Si layer and a Cu layer are laminated, and the thickness of a recording mark formed by an irradiation with a laser beam does not exceed the thickness of a neighboring space portion. The Cu layer is placed at the substrate 22 side, and the Si layer is placed at the cover layer 24 side. Incidentally, the refractive index of the Cu layer is 0.2, and the refractive index of the Si layer is 3.3. However, the refractive index n₁ of the first recording layer 14 as a whole cannot be determined.

Moreover, materials containing Bi, O, and Ge were employed as the materials for the second to sixth recording layers 16, 32, 34, 42, and 44. One optical recording medium was prepared in which the atomic ratios of Bi, O, Ge are different in each of the second to sixth recording layers 16, 32, 34, 42, and 44. The refractive indices of the second to sixth recording layers 16, 32, 34, 42, and 44 satisfy the relation n₂>n₃>n₄>n₅>n₆.

Each of the Si layer and the Cu layer in the first recording layer 14 was formed in a thickness of 6 nm, and thus the total thickness of the first recording layer 14 was 12 nm. Incidentally, a dielectric layer formed from a mixture of ZnS and SiO₂ (ZnS:SiO₂=80:20) was provided on each side of the first recording layer 14. The thickness of each of the dielectric layers was 40 nm. Moreover, a reflective layer formed from a AgPdCu alloy was provided between the substrate 22 and the dielectric layer on the side of the substrate 22. The thickness of the reflective layer was 100 nm.

On the other hand, the second recording layer 16, the third recording layer 32, the fourth recording layer 34, the fifth recording layer 42, and the sixth recording layer 44 were formed in thicknesses of 33 nm, 37 nm, 40 nm, 43 nm, and 46 nm, respectively. A dielectric layer formed from TiO₂ was provided on each side of the second to sixth recording layers 16, 32, 34, 42, and 44. The thickness of each dielectric layer provided on each side of the second recording layer 16 was 10 nm. The thickness of each dielectric layer provided on each side of the third to fifth recording layers 32, 34, and 42 was 14 nm. The thickness of each dielectric layer provided on each side of the sixth recording layer 44 was 15 nm.

This optical recording medium was measured for the reflectivity, the recording sensitivity, the 8T C/N value, and the extinction coefficient of each of the first to sixth recording layers 14, 16, 32, 34, 42, and 44. The measurement results are shown in Table 4. In addition to this, the compositions and the deposition conditions for the first to sixth recording layers 14, 16, 32, 34, 42, and 44 are also listed in Table 4.

TABLE 4

| | | | | | | | | | | | | Deposition conditions | | | |
|---|---|---|---|---|---|---|---|---|---|---|---|---|---|---|---|
| | | | | | | | | | | | | | | Gas | |
| | | | | | | | | | | | | Deposition | | flow | |
| | | | | Recording | | | | | | | | power | | rate | |
| | Refractive | Thickness | Reflectivity | sensitivity | 8T C/N | Extinction | Composition(at %) | | | | | (W) | | (sccm) | |
| | index | (nm) | (%) | (mW) | (dB) | coefficient K | Bi | O | Ge | Si | Cu | Bi | Ge | Ar | O₂ |
| Sixth recording layer | 1.9 | 46 | 4.4 | 10.8 | 61 | 0.07 | 20 | 67 | 13 | — | — | 70 | 300 | 50 | 15 |
| Fifth recording layer | 2.0 | 43 | 4.1 | 10.6 | 60 | 0.08 | 22 | 67 | 11 | — | — | 78 | 300 | 50 | 15 |
| Fourth recording layer | 2.2 | 40 | 3.1 | 11.4 | 58 | 0.11 | 22 | 68 | 10 | — | — | 80 | 290 | 50 | 15 |
| Third recording layer | 2.3 | 37 | 2.9 | 11.0 | 57 | 0.13 | 25 | 68 | 7 | — | — | 80 | 220 | 50 | 15 |
| Second recording layer | 2.4 | 33 | 2.9 | 12.0 | 57 | 0.15 | 28 | 70 | 2 | — | — | 150 | 200 | 50 | 20 |
| First recording layer | 3.3 | 6 | 2.1 | 12.2 | 57 | 1.85 | — | — | — | 100 | — | — | — | — | — |
| | 0.2 | 6 | | | | 3.71 | — | — | — | — | 100 | — | — | — | — |

### COMPARATIVE EXAMPLE

An optical recording medium similar to that in Working Example 1 was prepared in which the refractive index of the second recording, layer 16 is the same as that of the first recording layer 14.

Specifically, one optical recording medium was prepared in which the composition of the second recording layer 16 is the same as that of the first recording layer 14 of Working Example 1 above.

This optical recording medium was measured for the refractive index, the extinction coefficient, the reflectivity, the recording sensitivity, and the 8T C/N value of each of the first recording layer 14 and the second recording layer 16. The measurement results are shown in Table 5. In addition to this, the compositions and the deposition conditions for the first recording layer 14 and the second recording layer 16 are also listed in Table 5.

TABLE 5

| | | | | | | | | | Deposition conditions | | | |
|---|---|---|---|---|---|---|---|---|---|---|---|---|
| | | | | | | | | | Deposition | | Gas flow | |
| | | | Recording | | Extinction | Composition | | | power | | rate | |
| | Refractive | Reflectivity | sensitivity | 8T C/N | coefficient | (at %) | | | (W) | | (sccm) | |
| | index | (%) | (mW) | (dB) | k | Bi | X | O | Bi | X | Ar | O₂ |
| Second recording layer | 2.4 | 11.0 | 5.0 | 55 | 0.16 | 32 | 0 | 68 | 200 | — | 50 | 15 |
| First recording layer | 2.4 | — | — | — | 0.16 | 32 | 0 | 68 | 200 | — | 50 | 15 |

As shown in Tables 1 to 4, in each of the optical recording media of Working Examples 1 to 4, the 8T C/N value of each of the recording layers was favorable, i.e., 50 or more. That is, in each of the optical recording media of Working Examples 1 to 4, the recording mark 12 formed in each of the recording layers was found to be favorable.

In each of the optical recording media of Working Examples 1 to 4, the differences in the reflectivity detected by the photodetector 20 between the recording marks 12 in adjacent two recording layers were sufficiently small. That is, the larger detected reflectivity value was less than twice the smaller detected reflectivity value.

In each of the optical recording media of Working Examples 1 to 3, a plurality of the recording layers are formed mainly of common elements, Bi and O. Furthermore, the refractive index of a recording layer placed closest to the incident surface 18 of the laser beam is lower than that of the first recording layer 14 by 0.1 to 0.6. In other words, when the refractive index of the recording layer placed closest to the incident surface 18 of the laser beam is lower than that of the first recording layer 14 by 0.1 to 0.6, the difference in the reflectivity detected by the photodetector 20 between a plurality of the recording layers can be preferably suppressed to 4% or less. Furthermore, when the refractive index of the recording layer placed closest to the incident surface 18 of the laser beam is lower than that of the first recording layer 14 by 0.2 to 0.5, the difference in the reflectivity detected by the photodetector 20 between the recording layers can be more preferably suppressed to less than 3%.

In Working Example 4, the refractive index of the first recording layer 14 as a whole could not be determined as described above. In the second to sixth recording layers 16, 32, 34, 42, and 44, a recording mark having a thickness larger than that of a neighboring space portion was formed by the irradiation with the laser beam. Among these five recording layers, the difference in refractive index between the sixth recording layer 44 placed closest to the incident surface 18 of the laser beam and the second recording layer 16 placed farthest from the incident surface 18 of the laser beam was 0.5 (within the range of 0.2 to 0.5), and the difference in the reflectivity between these five recording layers was suppressed to less than 3%.

Furthermore, in each of the optical recording media of Working Examples 1 to 4, the differences in recording sensitivity between the recording layers were sufficiently small, i.e., 5 mW or less.

In each of the optical recording media of Working Examples 1 to 3, a plurality of the recording layers are formed mainly of common elements, Bi and O. Furthermore, the extinction coefficient of a recording layer placed closest to the incident surface 18 of the laser beam is lower than that of the first recording layer 14 by 0.02 to 0.14. In other words, in the case where the plurality of the recording layers are formed mainly of common elements, when the extinction coefficient of the recording layer placed closest to the incident surface 18 of the laser beam is lower than that of the first recording layer 14 by 0.02 to 0.14, the difference in extinction coefficient between the recording layers can be preferably suppressed to 5 mW or less. Furthermore, when the extinction coefficient of the recording layer placed closest to the incident surface 18 of the laser beam is lower than that of the first recording layer 14 by 0.02 to 0.07, the difference in recording sensitivity between the recording layers can be more preferably suppressed to 3 mW or less.

In Working Example 4, the main components of the first recording layer 14 are different from the main components of the other recording layer as described above, and the extinction coefficient of the first recording layer 14 is significantly higher than that of the other recording layers. Therefore, the relations mentioned above are not satisfied if the first recording layer 14 is included in Working Example 4. However, also in Working Example 4, the second to sixth recording layers 16, 32, 34, 42, and 44 are formed mainly of the common elements. For these five recording layers, the extinction coefficient of the sixth recording layer 44 placed closest to the incident surface 18 of the laser beam was lower than that of the second recording layer 16 placed farthest from the incident surface 18 of the laser beam by 0.08 (within the range of 0.02 to 0.14). Furthermore, the differences in recording sensitivity between these five recording layers having the common main elements were suppressed to 5 mW or less.

On the other hand, in the optical recording medium of the Comparative Example, the refractive index of the second recording layer 16 was the same as that of the first recording layer 14. Though an attempt was made to focus a laser beam on the first recording layer 14, the laser beam was focused on the second recording layer 16. Therefore, a recording mark could not be formed in the first recording layer 14. Accordingly, the first recording layer 14 could not be evaluated. This might be because the reflectivity of the first recording layer 14 detected by the photodetector 20 was excessively lower than that of the second recording layer 16.

What is claimed is:

1. An optical recording medium comprising a plurality of recording layers in which a recording mark, having an increased thickness larger than the thickness of a neighboring space portion, is formed by an irradiation with a laser beam, wherein
among the plurality of recording layers, a recording layer placed relatively closer to an incident surface of the laser beam has a refractive index lower than that of a recording layer placed farther away from the incident surface of the laser beam than the recording layer placed relatively closer to the incident surface of laser beam.

2. An optical recording medium comprising a plurality of recording layers in which a recording mark, having an increased thickness larger than the thickness of a neighboring space portion, is formed by an irradiation with a laser beam, wherein
among the plurality of recording layers, a recording layer placed relatively closer to an incident surface of a laser beam has an extinction coefficient lower than that of each recording layer placed farther away from the incident surface of the laser beam than the recording layer placed relatively closer to the incident surface of the laser beam.

3. The optical recording medium according to claim 1, wherein the optical recording medium includes three or more recording layers, and wherein, among these recording layers, at least a plurality of recording layers placed closer to the incident surface of the laser beam than a recording layer placed farthest away from the incident surface of the laser beam are the recording layers in which the recording mark having an increased thickness larger than that of the neighboring space portion is formed by the irradiation with the laser beam.

4. The optical recording medium according to claim 2, wherein the optical recording medium includes three or more recording layers, and wherein, among these recording layers, at least a plurality of recording layers placed closer to the incident surface of the laser beam than a recording layer placed farthest away from the incident surface of the laser beam are the recording layers in which the recording mark having an increased thickness larger than that of the neighboring space portion is formed by the irradiation with the laser beam.

5. The optical recording medium according to claim 1, wherein the plurality of recording layers have the same thickness.

6. The optical recording medium according to claim 2, wherein the plurality of recording layers have the same thickness.

7. The optical recording medium according to claim 1, wherein, among the plurality of recording layers, a recording layer placed relatively closer to the incident surface of the laser beam has a thickness larger than that of a recording layer placed farther away from the incident surface of the laser beam than the recording layer placed relatively closer to the incident surface of the laser beam.

8. The optical recording medium according to claim 2, wherein, among the plurality of recording layers, a recording layer placed relatively closer to the incident surface of the laser beam has a thickness larger than that of a recording layer placed farther away from the incident surface of the laser beam than the recording layer placed relatively closer to the incident surface of the laser beam.

9. The optical recording medium according to claim 1, wherein, among the plurality of recording layers, a recording layer placed closest to the incident surface of the laser beam has a refractive index lower than that of a recording layer placed farthest away from the incident surface of the laser beam by 0.1 to 0.6.

10. The optical recording medium according to claim 2, wherein, among the plurality of recording layers, a recording layer placed closest to the incident surface of the laser beam has a refractive index lower than that of a recording layer placed farthest away from the incident surface of the laser beam by 0.1 to 0.6.

11. The optical recording medium according to claim 1, wherein, among the plurality of recording layers, a recording layer placed closest to the incident surface of the laser beam has an extinction coefficient lower than that of a recording layer placed farthest away from the incident surface of the laser beam by 0.01 to 0.20.

12. The optical recording medium according to claim 2, wherein, among the plurality of recording layers, a recording layer placed closest to the incident surface of the laser beam has an extinction coefficient lower than that of a recording layer placed farthest away from the incident surface of the laser beam by 0.01 to 0.20.

13. The optical recording medium according to claim 1, wherein a material for the recording layers has a property in which its reflectivity in the space portion varies according to the thickness thereof and the reflectivity of the space portion becomes maximum at a predetermined thickness, and wherein each of the recording layers is formed in thickness which give a maximum reflectivity to the space portion thereof.

14. The optical recording medium according to claim 2, wherein a material for the recording layers has a property in which its reflectivity in the space portion varies according to the thickness thereof and the reflectivity of the space portion becomes maximum at a predetermined thickness, and wherein each of the recording layers is formed in thickness which give a maximum reflectivity to the space portion thereof.

15. The optical recording medium according to claim 1, wherein, among the plurality of recording layers, at least one recording layer placed closer to the surface of the laser beam incident than a recording layer placed farthest away from the incident surface of the laser beam essentially consists of Bi and O, and wherein the ratio of the number of O atoms therein is 62% or more.

16. The optical recording medium according to claim 2, wherein, among the plurality of recording layers, at least one recording layer placed closer to the surface of the laser beam incident than a recording layer placed farthest away from the incident surface of the laser beam essentially consists of Bi and O, and wherein the ratio of the number of O atoms therein is 62% or more.
